(19) United States
(12) Patent Application Publication
(10) Pub. No.: US 2012/0070739 A1
(43) Pub. Date: Mar. 22, 2012

(54) GALVANIC ELEMENT HAVING A MERCURY-FREE NEGATIVE ELECTRODE

(75) Inventors: Kemal Akca, Ellwangen (DE); Thomas Haake, Ellwangen (DE); Stefan Senz, Unterschneidhim (DE); Hermann Löffelmann, Ellwangen-Eigenzell (DE); Eduard Pytlik, Ellwangen (DE); Volker Stuber, Buhlerzell (DE)

(73) Assignee: VARTA MICROBATTERY GMBH, Ellwangen (DE)

(21) Appl. No.: 13/319,358

(22) PCT Filed: May 17, 2010
(86) PCT No.: PCT/EP10/03012

§ 371 Date: Nov. 8, 2011

(30) Foreign Application Priority Data
May 20, 2009 (DE) 10 2009 023 126.9

(51) Int. Cl. H01M 4/38; B05D 5/12; B22F 3/02; H01B 1/02; B82Y 30/00

(52) U.S. Cl. 429/218.1; 419/66; 252/512; 427/123; 977/742

(57) ABSTRACT

A galvanic element includes a mercury-free negative electrode which consists essentially of a metal or a metal alloy and a nonmetallic conductive agent. A method for producing a galvanic element includes a mercury-free negative electrode produced from a powder of metal or metal alloy particles, surfaces of which are at least partially coated with a nonmetallic conductive agent.

### RELATED APPLICATIONS

This is a §371 of International Application No. PCT/EP2010/003012, with an international filing date of May 17, 2010 (WO 2010/133331 A1, published Nov. 25, 2010), which is based on German Patent Application No. 10 2009 023 126.9, filed May 20, 2009, the subject matter of which is incorporated by reference.

### TECHNICAL FIELD

This disclosure relates to a galvanic element (an electrochemical cell) which is characterized, in particular, by a mercury-free negative electrode. The disclosure furthermore relates to a method by which such galvanic elements having a mercury-free negative electrode can be produced.

### BACKGROUND

Galvanic elements such as batteries and accumulators are currently employed in a wide variety of fields. They serve, in particular, to supply portable devices with electrical energy. In very small devices such as watches and hearing aids, the galvanic elements are preferably used in the form of button cells. Hearing aids, in particular, have a relatively high electricity consumption. For this reason, hearing aids are generally supplied using batteries comprising the electrochemical system zinc-air, which are characterized by a particularly high capacity. Commercially available zinc-air batteries are not rechargeable, and accordingly have to be disposed of after use. This, however, is problematic since they may contain up to about 1 wt % of mercury, which should not enter the environment.

Mercury has the function in electrodes, for example, in the anodes of zinc-air and silver oxide batteries, inter alia of improving the electrical contact between the individual zinc particles. It therefore increases the total internal conductivity of the electrodes. This is very important particularly in the state of progressive discharge. The reason is that the conductive active material zinc is converted during the discharge into nonconductive zinc oxide, so that the current conduction inside the electrode is opposed by ever-greater resistances. Without sufficient addition of mercury, therefore, in general not all the zinc particles are converted into zinc oxide owing to poor electrical contact inside an electrode. The theoretical energy content of an electrode is accordingly not fully exploited.

Notwithstanding the above, due to the potential harmfulness of mercury for the environment and for human and animal health, there is, however, a need to fully eliminate its use in the medium term. There is, therefore, a demand for galvanic elements, particularly those of the button cell type, which are free of mercury.

It could therefore be helpful to provide such galvanic elements. More particularly, it could be helpful to provide electrodes which are optimized with respect to the aforementioned problem of incomplete zinc conversion and which are at least not substantially inferior in this regard to electrodes containing mercury.

### SUMMARY

We provide a button cell including a mercury-free negative electrode which consists essentially of a metal or a metal alloy and a nonmetallic conductive agent.

We also provide a method for producing the button cell, wherein the negative electrode is produced from a powder of metal or metal alloy particles, surfaces of which are at least partially coated with a nonmetallic conductive agent.

### BRIEF DESCRIPTION OF THE DRAWINGS

FIG. 1 is a graph showing voltage over time for a comparison cell.

FIG. 2 is a graph showing voltage over time for one of our cells.

### DETAILED DESCRIPTION

Our galvanic element comprises a mercury-free negative electrode, which is characterized, in particular, in that it consists essentially only of a metal or a metal alloy and a nonmetallic conductive agent.

Surprisingly, it has been found that the proportion of mercury used in known negative electrodes of galvanic elements can be replaced by a nonmetallic conductive agent, without leading to incomplete discharge of the cell due to internal contact problems in the negative electrode.

Particularly preferably, the negative electrode of a galvanic element consists essentially of particles of the metal or the metal alloy, surfaces of which are at least partially coated with the nonmetallic conductive agent. In the electrode, these individual particles (besides direct contact existing between the particles) are additionally in electrical contact with one another via the nonmetallic conductive agent. This leads to outstandingly good discharge properties of a galvanic element.

The nonmetallic conductive agent is preferably contained in the mercury-free negative electrode in a proportion of 0.01 wt % to 5 wt %. Within this range, proportions of 0.05 wt % to 1.5 wt %, in particular 0.1 wt % to 0.3 wt %, are more preferred.

As mentioned above, the mercury-free negative electrode of a galvanic element consists “essentially” of the metal or the metal alloy and the nonmetallic conductive agent. The qualification “essentially” is to be interpreted as meaning that the negative electrode only contains other additives conventional for electrodes (naturally other than mercury) in very small amounts in addition to the aforementioned components. Preferably, the proportion of such additives in the negative electrode is generally not more than 5 wt %. It is preferably less than 1.5 wt %.

Thus, preferably, our galvanic element has a negative electrode which also comprises a binder such as a conventional additive in addition to the aforementioned components, and particularly in a proportion of 0.01 wt % to 5 wt %. Within this range, proportions of 0.05 wt % to 1.5 wt %, in particular to 0.1 wt % and 0.3 wt %, are more preferred.

The metal or the metal alloy for the negative electrode is preferably zinc or a zinc alloy. Preferably, the galvanic element may therefore be a zinc-air or silver oxide battery.

It may furthermore be preferable for the metal or the metal alloy to be a hydrogen storage alloy. Hydrogen storage alloys suitable for batteries are well known to those skilled in the art, so-called AB₅ alloys being suitable, in particular, i.e., for example, an alloy consisting of one or more rare earth metals such as lanthanum and nickel in a ratio of 1:5. Optionally, the hydrogen storage alloy may also contain one or more further metals as additives. Preferably, the galvanic element may thus, for example, also be a nickel-metal hydride battery, i.e., a rechargeable battery.

The nonmetallic conductive agent is preferably a carbon-based conductive agent. Carbon black and/or graphite are particularly preferably suitable, although it is also possible to use carbon nanotubes (CNTs). Mixtures of two or three of the carbon modifications may also be employed. Carbon materials suitable as conductive agents such as conductive carbon black or conductive graphite are commercially available and need not be explained in detail. The same also applies to the aforementioned carbon nanotubes.

The nonmetallic conductive agent itself is preferably essentially fully free of metal components or impurities. Preferably, at least 99.9 wt % consists of carbon.

Concerning the binders which may be used for the negative electrode, it is also possible to employ commercially available products. A binder based on carboxymethyl cellulose and/or based on a carboxymethyl cellulose derivative may particularly preferably be used here.

The galvanic element is particularly preferably a button cell. As such, the galvanic element preferably has a metal housing consisting of two half parts, namely a cell cup and a cell lid. Cell cups and cell lids made of nickel-plated steel or of a so-called “trimetal” (a layer arrangement of three metals) are particularly suitable. In particular, sheet steel with an internal coating of copper and an external coating of nickel may be used as a trimetal.

Our galvanic element may, in particular, be produced according to the method described below.

Our method is suitable for the production of galvanic elements having mercury-free negative electrodes such as, for example, the galvanic elements as described above.

The method is characterized in that the negative electrode is produced from a powder of metal or metal alloy particles, surfaces of which are at least partially coated with a nonmetallic conductive agent.

The at least partial coating of the surface of the particles of the metal or the metal alloy is a particularly important aspect in this case. Preferably, the method comprises an initial coating step in which a starting powder of metal or metal alloy particles is mixed intensively with the nonmetallic conductive agent.

Intensive mixing is in this case intended to mean that the mixing process is carried out such that the surface of the particles of the starting powder is at least partially, in particular fully, covered with the nonmetallic conductive agent after the mixing. As suitable devices which ensure such intensive mixing, it is, for example, possible to use mechanical mixers or mills. Particularly when using the latter, it is simultaneously also possible to adjust the average particle size of the metal or metal alloy particles in a controlled way.

Preferably, particles having an average particle size of 1 μm to 500 μm, in particular 40 μm to 400 μm, are used as the starting powder. Depending on the mixing process, the resulting particles with a surface coated at least partially with the nonmetallic conductive agent will likewise have a particle size in this range. Naturally, however, the particle size may also differ up or down.

The conductive agent is generally used in powder form, particularly preferably. it has an average particle size of 2 μm to 20 μm.

In accordance with the explanations above concerning the preferred galvanic elements, at least one further additive in addition to the nonmetallic conductive agents, in particular a binder, may also be added to the metal or metal alloy particles. Optionally, this is preferably done before and/or during the mixing process.

Preferably, the mixing process is carried out dry. This is intended to mean that no liquids are added to the components to be mixed, in particular no water. Preferably, mixing may be carried out under a protective (inert) gas to protect the material being mixed from air moisture.

Naturally, it is also possible to add electrolyte solution or another liquid to the mixture of the powder and the conductive agent, and optionally the at least one further additive, before and/or during the mixing process. The mixing process then generally produces a paste, which can be further processed directly to form an electrode.

The powder obtained from the mixing process carried out dry may naturally likewise be converted into paste form by adding electrolyte, although it is preferably further processed dry. Thus, a pressing may, for example, be produced from the powder, which can subsequently be employed as a negative electrode.

Preferably, the powder for the production of a negative electrode may also be poured directly into a housing half part, in particular, the negative housing half part of the galvanic element to be produced. In both cases, the addition of electrolyte is then subsequently carried out.

The powder of the metal or metal alloy particles with the at least partially coated surface is particularly suitable for dry further processing. It has been found that such powders are characterized by a particularly high flowability and pourability.

The aforementioned advantages and further advantages may be found from the description of preferred forms which now follow, in conjunction with the drawings. In this context, the individual features may be implemented separately or in combination with one another. The examples described merely serve for explanation and better understanding, and are in no way to be interpreted as restrictive.

### EXAMPLE

To produce a galvanic element, carbon black and carboxymethyl cellulose as a binder were added to a zinc powder having an average particle size of about 200 μm. The proportions of the carbon black and the binder were respectively about 0.15 wt %, and the proportion of zinc was about 99.7 wt %. The three components were mixed intensively with one another in a mechanical mixing device. The powder thereby obtained was subsequently poured into the cell lid of a button cell housing, and an alkaline electrolyte was added to it. The cell lid was subsequently combined with a suitable seal and then with a matching cell cup containing an air-oxygen electrode. The cell was closed by crimping the cut edge of the cell cup over the side of the cell lid.

To produce a comparison cell, a similar procedure was adopted but no carbon black was added. The proportion of the binder was about 0.15 wt %, and the proportion of zinc was about 99.85 wt %.

Discharge tests were carried out with our galvanic element and with the comparison cell. The results of these tests are represented in the drawings.

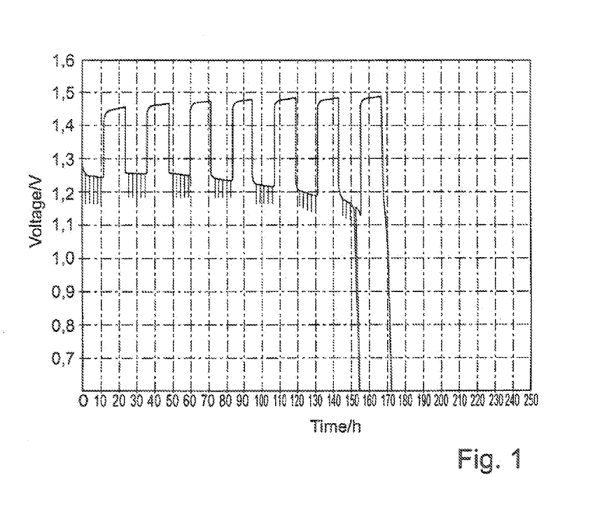

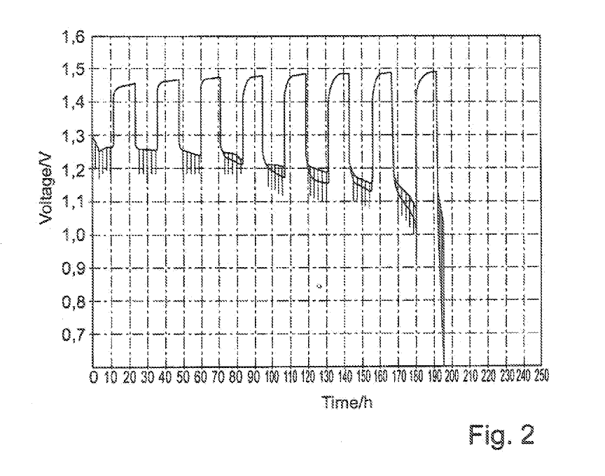

FIG. 1 represents the discharge diagram of the comparison cell, and FIG. 2 represents that of our galvanic element. As is immediately apparent, our galvanic element provides voltage for much longer than the comparison cell. This is attributable to the fact that the zinc in the negative electrode of our galvanic element is fully converted.

1. A button cell comprising a mercury-free negative electrode which consists essentially of a metal or a metal alloy and a nonmetallic conductive agent.

2. The button cell as claimed in claim 1, wherein the negative electrode consists essentially of particles of the metal or the metal alloy, surfaces of which are at least partially coated with the nonmetallic conductive agent.

3. The button cell as claimed in claim 1, wherein the negative electrode contains the nonmetallic conductive agent in a proportion of 0.01 wt % to 5 wt %.

4. The button cell as claimed in claim 1, wherein the negative electrode contains a binder in a proportion of 0.01 wt % to 5 wt %.

5. The button cell as claimed in claim 1, wherein the metal or the metal alloy is zinc, a zinc alloy or a hydrogen storage alloy.

6. The button cell as claimed in claim 1, wherein the nonmetallic conductive agent is at least one selected from the group consisting of carbon black, graphite and carbon nanotubes (CNTs).

7. The button cell as claimed in claim 1, wherein the nonmetallic conductive agent is essentially free of metallic impurities.

8. The button cell as claimed in claim 4, wherein the binder is carboxymethyl cellulose and/or a derivative thereof.

9. A method for producing the button cell as claimed claim 1, wherein the negative electrode is produced from a powder of metal or metal alloy particles, surfaces of which are at least partially coated with a nonmetallic conductive agent.

10. The method as claimed in claim 9, wherein a starting powder of metal or metal alloy particles is mixed with the nonmetallic conductive agent for the at least partial coating of the particle surface.

11. The method as claimed in claim 10, wherein the starting powder contains particles having an average particle size of 1 μm to 500 μm.

12. The method as claimed in claim 10, wherein the conductive agent is in powder form with an average particle size of 2 μm to 20 μm.

13. The method as claimed in claim 10, wherein at least one further additive in addition to the nonmetallic conductive agent is added to the metal or metal alloy particles preferably before and/or during the mixing process.

14. The method as claimed in claim 10, wherein the mixing process is carried out dry.

15. The method as claimed in claim 10, wherein an electrolyte solution is added to the mixture of the powder and the conductive agent before and/or during the mixing process.

16. The method as claimed in claim 9, wherein the powder of the metal or metal alloy particles with the at least partially coated surface is processed dry or as a paste.

17. The method as claimed in claim 9, wherein the powder of metal or metal alloy particles with the at least partially coated surface for the production of the negative electrode is poured into a negative housing half part of a galvanic element to be produced.
